(19) United States
(12) Patent Application Publication
(10) Pub. No.: US 2009/0121968 A1
(43) Pub. Date: May 14, 2009

(54) Electronic Device

(75) Inventor: Satoshi OKAMOTO, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/190,456

(22) Filed: Aug. 12, 2008

(30) Foreign Application Priority Data
Nov. 8, 2007 (JP) 2007-290966

(51) Int. Cl. G09G 5/00

(52) U.S. Cl. 345/1.1

(57) ABSTRACT

An electronic device includes first display means that displays an image in monochrome, first control means that controls the display of the monochrome image, and interface means that is used to communicate with the first control means. When second control means that controls second display means is connected to the interface means, the first control means communicates with the second control means via the interface means.

### CROSS-REFERENCE TO RELATED APPLICATION

This application claims priority under 35 U.S.C. 119 to Japanese Patent Application No. 2007-290966, filed on Nov. 8, 2007, which application is hereby incorporated by reference in its entirety.

### BACKGROUND OF THE INVENTION

1. Field of the Invention

The present invention relates to an electronic device that includes a Liquid Crystal Display (LCD) and, more specifically, relates to an electronic device in which the type of LCD can be easily changed in accordance with the grade of a model.

2. Description of the Related Art

An electronic device has been conventionally known in which either a monochrome LCD or a color LCD is selected and attached. In such an electronic device including the above-described configuration, the type of LCD can be changed, and a product lineup that is widely compatible with the grade required by a user can be easily expanded. By standardizing the configuration other than the LCD and a control unit of the LCD, the development period for the product can be shortened, and the manufacturing cost can be reduced. Moreover, needs for future expansion of the model and change of specification can be flexibly responded to.

Two approaches have been used in the conventional art for an electronic device in which either a monochrome LCD or a color LCD can be selected. One approach configures a circuit on the assumption that the color LCD is to be attached. When the monochrome LCD is attached, a gate array used for the color LCD is removed, and a terminal connected to the gate array is pulled up. The other approach includes a video circuit unit by which a computer can respond to both a color display and a monochrome display, determines whether the LCD connected to a connector is the color LCD or monochrome LCD, and controls the color display or monochrome display.

In the electronic device in which the monochrome LCD or the color LCD can be selected, as seen in the above-described conventional art, it is necessary to provide hardware that controls the color display. The data amount of the color LCD is larger than the data amount of the monochrome LCD. Therefore, the hardware used for the color display tends to be complicated and expensive. Moreover, when the monochrome LCD is attached, the hardware for the color LCD becomes useless.

On this point, the conventional art includes the hardware that controls the color display, thereby creating a need for simplification of a circuit configuration and reduction of the cost.

### SUMMARY OF THE INVENTION

In order to overcome the problems described above, the present invention provides an electronic device in which a product lineup compatible with various types of an LCD (such as a monochrome LCD and a color LCD) to be attached can be easily achieved, a circuit configuration can be simplified, and the cost can be reduced.

One embodiment of the present invention provides a first control unit that can control a first LCD, which is a monochrome LCD, and an interface that is used for communicating with the first control unit. When a second control unit, which controls a second LCD, is connected to the interface, the first control unit communicates with the second control unit via the interface.

when the second LCD, which is different from the first LCD, is connected to the electronic device, the second control unit communicates with the first control unit and controls the second LCD. Since the second control unit controls the second LCD, the burden on the first control unit can be reduced. Accordingly, the electronic device can be provided in which a configuration of the first control unit can be simplified, the cost can be reduced, and the LCD of various types can be used.

In one embodiment of the present invention, the second LCD is a color LCD, and the color LCD, which handles a large amount of data, can be used. Moreover, the second control unit performs complex calculation needed for color display, and therefore, the configuration of the first control unit can be simplified.

In one embodiment of the present invention, the interface is a serial interface. Since the second control unit is connected via the serial interface in which a cable can be easily thinned, the cable in the electronic device can be easily handled, and the second control unit can be arranged at a proper position, enhancing scalability. Further, since the serial interface that enables high-speed communication is used, even when the data amount handled between the first and second control units is large, the data content can be smoothly displayed on the second LCD.

In one embodiment of the present invention, by communicating with the second control unit, the first control unit acquires the contents of operations performed by an operation unit connected to the second control unit. When the operation unit is added along with the second LCD, the first control unit recognizes the contents of operations performed by the added operation unit, and properly processes the operations. Accordingly, the product lineup in which the operation unit is changed can be easily achieved.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram illustrating a configuration of a standard monochrome LCD specification provided in a Multi Function Peripheral (MFP) according to one embodiment of the present invention.

FIG. 2 is a block diagram illustrating a configuration of a color LCD specification provided in the MFP.

FIG. 3 is a flowchart of the control of an LCD display of the MFP.

### DETAILED DESCRIPTION OF PREFERRED EMBODIMENTS

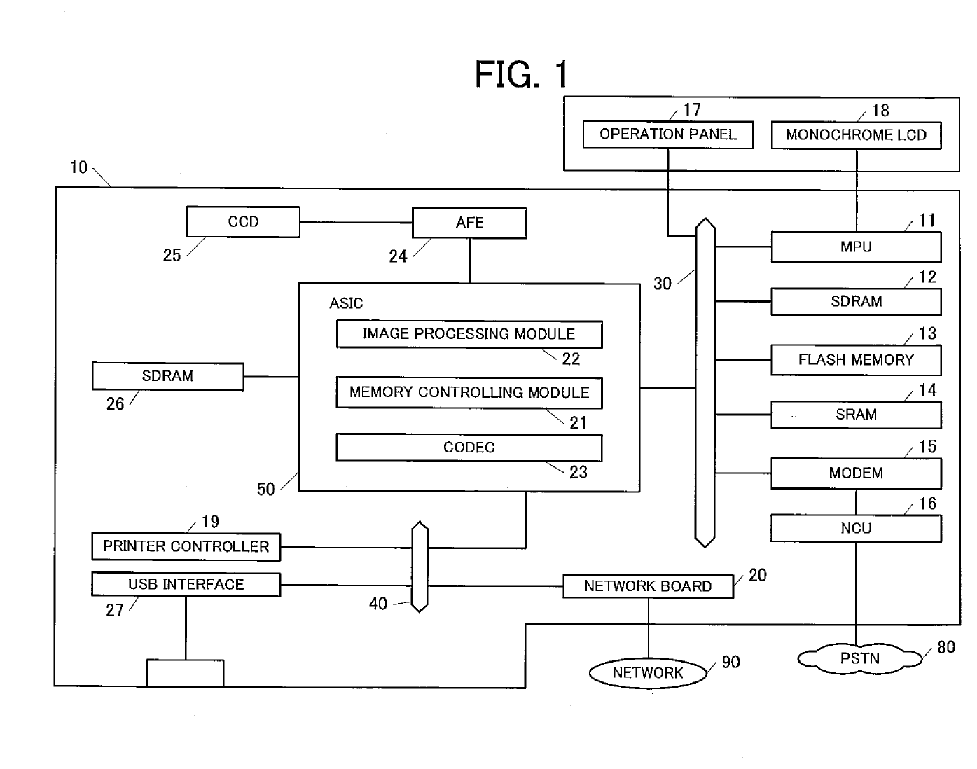

An embodiment of the present invention is now described with reference to the drawings. FIG. 1 is a block diagram of an example in which a monochrome LCD 18 is connected to an MFP 10 including a copier function and a facsimile function according to an embodiment of the present invention.

As illustrated in FIG. 1, the MFP 10 of the present embodiment includes a Micro Processing Unit (MPU) 11, a Synchronous Dynamic Random Access Memory (SDRAM) 12, and a flash memory 13. The MPU 11, the SDRAM 12, and the flash memory 13 are connected to each other via a local bus 30.

The MPU 11 is a control unit that controls the entire MFP. The MPU 11 reads and executes various programs stored in the flash memory 13, and performs functions such as a facsimile function, a scanner function, and a copier function, which are described later. The SDRAM 12 is a memory that can read and write, and is used as a working area for executing the programs.

A static RAM (SRAM) 14 and a modem 15 are connected to the local bus 30. The SRAM 14 stores various user settings such as speed dial, and the stored content is backed up by using a battery. The modem 15 includes a function of modulating data into an audio frequency signal and a function of demodulating the audio frequency signal into the data, and is connected to a Network Control Unit (NCU) 16. The NCU 16 is connected with a Public Switched Telephone Network (PSTN) 80, and can communicate via facsimile with a destination.

An operation panel 17 is connected to the local bus 30. The operation panel 17 includes various keys such as a numeric keypad, cursor keys, a start key, and a cancel key. A user uses these keys to instruct the MFP 10 to perform copying or facsimile transmission.

The monochrome LCD 18 is connected to the MPU 11. In the monochrome LCD 18, characters and graphics etc. are expressed in black-and-white two levels. In the present embodiment, the operation panel 17 and the monochrome LCD 18 are formed as an integrated assembly (ASSY), and the entire ASSY can be attached to the MFP 10.

The MPU 11 includes an LCD controller to control the monochrome LCD 18. Characters, symbols, and graphics, etc. are displayed on the monochrome LCD 18 by the LCD controller.

The MFP 10 includes a Peripheral Component Interconnect (PCI) bus 40, and the local bus 30 is connected to the PCI bus 40 via an Application Specific Integrated Circuit (ASIC) 50 that is used to perform image processing in the present embodiment. The MPU 11 exchanges via the ASIC 50 data with various devices connected to the PCI bus 40.

A Charge Coupled Device (CCD) 25 is connected to the ASIC 50 via an Analog Front End (AFE) 24. The CCD 25 is provided in a document scanning unit (not illustrated). An image signal of a document scanned by the CCD 25 is converted by the AFE 24 from an analog signal into a digital signal, and then input into the ASIC 50. The CCD 25 includes a color filter that separates three primary colors, and can scan the document.

An SDRAM 26 that functions as an image memory is connected to the ASIC 50. The data coded in the ASIC 50, for example, is stored in the SDRAM 26.

Next, the ASIC 50 will be described. The ASIC 50 includes a memory controlling module 21, an image processing module 22, and a coder and decoder (codec) module 23 etc. Further, the ASIC 50 includes an ASIC controlling module and a Direct Memory Access (DMA) controlling module (not illustrated). The ASIC controlling module and the DMA controlling module control the memory controlling module 21, the image processing module 22, and the codec module 23 etc., and exchange the data between the local bus 30 and the PCI bus 40.

The image processing module 22 performs shading correction, gamma correction, and edge enhancement, etc. on the image data input from the AFE 24.

The memory controlling module 21 receives the image data processed by the image processing module 22, and executes various processes such as an image rotating process that adjusts a printing direction and a paper direction, and a reduction process that makes a combined copy, or the like, in accordance with the user settings.

The codec module 23 compresses or expands the image data by using a publicly-known compression format such as a Modified Haffman (MF), Modified Read (MR), a Modified MR (MMR), and a Joint Photographic Experts Group (JPEG). The codec module 23 codes the image data of the scanned document, or decodes image data received via facsimile transmission.

An optional unit such as a printer controller 19 and a network board 20 is connected to the PCI bus 40. The printer controller 19 adds a printer function to the MFP 10, converts a Page Description Language (PDL) received from a personal computer (not illustrated) or the like connected to the MFP 10, into raster data, and prints the data on a sheet of paper by using an image forming unit of the MFP 10. The network board 20 connects the MFP 10 to the network 90 so as to communicate with other nodes in accordance with a Transmission Control Protocol/Internet Protocol (TCP/IP). A network printing function, in which the PDL is received from the personal computer connected to the network 90 and printed, can be implemented by the printer controller 19 and the network board 20.

A universal Serial Bus (USB) interface 27 is connected to the PCI bus 40, and a USB device is connected to the USB interface 27. The USB interface 27 includes a USB host controller (not illustrated), and operates the USB device by communicating with a function controller provided in the connected USB device.

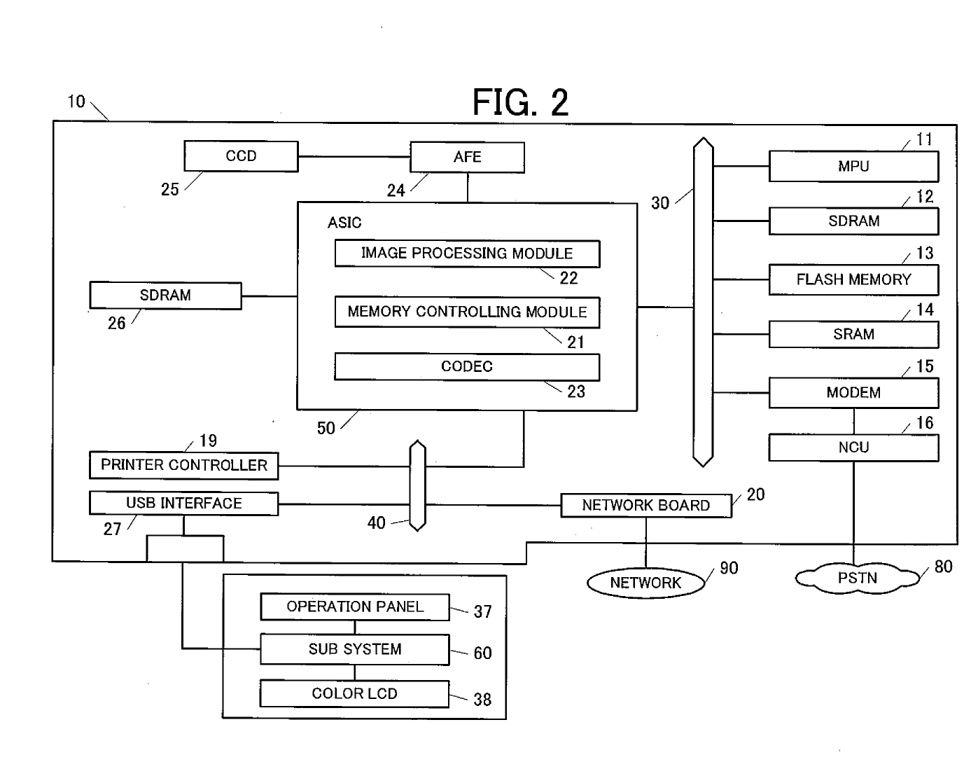

The USB interface 27 of the present embodiment is compatible with a high speed mode of USB 2.0, and high-speed communication can be achieved by using the USB interface 27, As illustrated in FIG. 2, a sub system 60 to be described later can be connected to the USB interface 27 along with a color LCD 38 and an operation panel 37. A color LCD specification in which the color LCD 38 is connected will be described later.

In the configuration of a monochrome LCD specification of FIG. 1, the LCD controller provided in the MPU 11 controls the monochrome LCD 18 to display an image on the monochrome LCD 18. The monochrome LCD 18 is controlled by the LCD controller of the MPU 11, and displays various pieces of information in black-and-white two levels (1 bit/pixel) on a liquid crystal screen. While referencing the content displayed on the monochrome LCD 18, the user can operate the operation panel 17 and instruct the MFP 10 to perform various operations.

With reference to FIG. 2, an example in which the color LCD 38 is connected to the MFP 10 of the present embodiment will be described. FIG. 2 is a block diagram of a configuration in which the color LCD 38 is connected to the MFP 10.

In order to change a monochrome LCD specification model of FIG. 1 to a color LCD specification model of upper grade, the operation panel 17 and the monochrome LCD 18 illustrated in FIG. 1 are omitted. As illustrated in FIG. 2, the unit formed of the sub system 60, the operation panel 37, and the color LCD 38 is connected to the USB interface 27 via a USB connector.

As is apparent from a comparison between FIGS. 1 and 2, the color LCD specification model of the MFP 10 uses many configurations of the standard monochrome LCD specification model. By these configurations, the development period for the product can be shortened, and the cost can be reduced.

The color LCD 38 represents each light intensity of red, green, and blue in 256 levels (true color), and adopts an RGB calorimetric system that enables various color displays by combining each color. On the screen of the color LCD 38, the content and instructions of the various operations are displayed in characters and graphics etc.

The sub system 60 is a micro computer including a Central Processing Unit (CPU) etc., and is connected to the USB interface 27. The sub system 60 communicates with the MPU 11 on a main system side of the MFP 10 via the USB interface 27, and controls the color LCD 38. The operation panel 37 and the color LCD 38 are connected to the sub system 60. In the present embodiment, the sub system 60 is connected to the color LCD 38 via a parallel interface.

When the user operates the operation panel 37, the sub system 60 and the MPU 11 communicate with each other so as to exchange data of the operation performed through the operation panel 37 and control the MFP 10 in accordance with the operation. The sub system 60, the color LCD 38, and the operation panel 37 are integrally formed as a unit. In the present embodiment, the unit is integrally attached to a chassis of the MFP 10 as if it is built in.

In the above-described configuration, the sub system 60 communicates the data with the MPU 11 on the main system side via the function controller of the sub system 60 and the USB host controller of the USB interface 27.

FIG. 2 illustrates the example in which the color LCD 38 is connected to the sub system 60, however, the monochrome LCD can also be connected to the sub system 60. When the color LCD 38 is connected, the sub system 60 loads display data (such as font data) for the color LCD and displays the data on the color LCD 38. When the monochrome LCD is connected, the sub system loads display data for the monochrome LCD and displays the data on the monochrome LCD. Thus, the sub system 60 determines a displaying capability of the LCD connected to the sub system 60, and controls the LCD in accordance with the displaying capability thereof.

The sub system 60 also controls option functions. The option functions include various functions that are added to the MFP 10 when the sub system 60 is attached to the MFP 10. In the present embodiment, a function of displaying, as a thumbnail on the color LCD 38, an image file stored in the main system side of the MFP 10 is used as the option function.

In order to implement the displaying function for the thumbnail, the USB host controller of the USB interface 27 on the main system side and the USB controller of the sub system 60 communicate with each other and exchange thumbnail data. Having received the thumbnail data, the sub system 60 decodes the data so as to display the data on the color LCD 38, and also converts a CbCr calorimetric system into the RGB calorimetric system so as to display the data on the color LCD 38. Thus, by controlling the option functions by the sub system 60, the burden on the MPU 11 can be reduced, a configuration of the MPU 11 can be simplified, and the cost can be reduced.

As described above, the sub system 60 is connected to the USB interface 27, and the data can be communicated in high speed between the MPU 11 on the main system side and the sub system 60 via the USB interface 27.

The data amount of the color display of RGB in 256 levels is larger than the data amount of the monochrome, two-level display. Accordingly, controlling the display of the color image only by the MPU 11 on the main system side can increase the burden on the MPU 11. In the present embodiment, however, since the sub system 60 controls the color display, the burden on the MPU 11 does not substantially increase. Moreover, since the side of the sub system 60 executes the option functions etc. such as the thumbnail, the burden on the system on the main body side can be reduced.

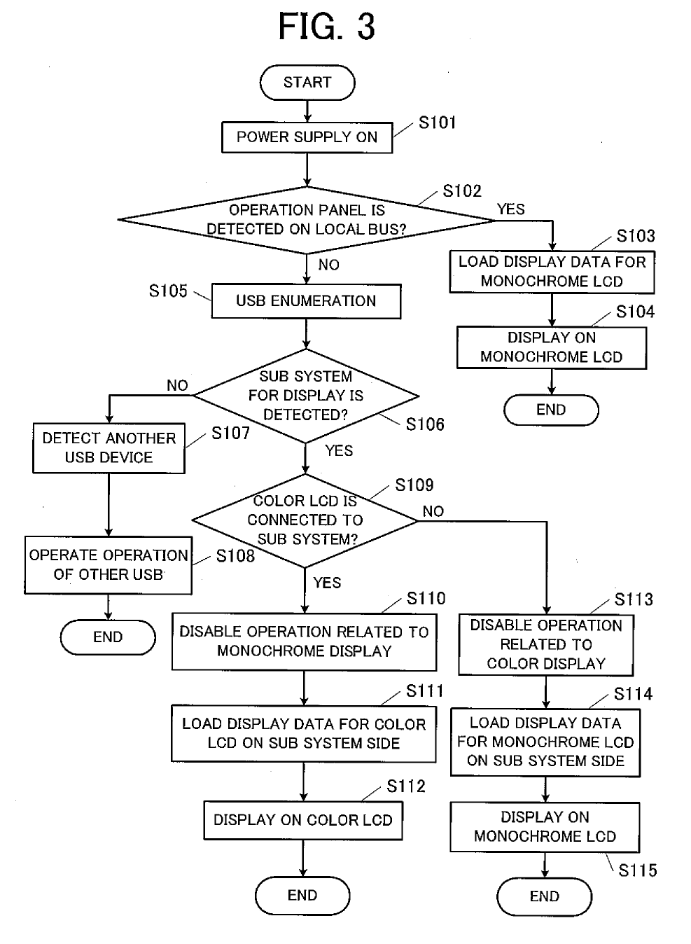

With reference to FIG. 3, the control of the LCD display of the MFP 10 will be described. FIG. 3 is a flowchart of the control of the LCD connected to the MFP 10 of the present embodiment.

In the flowchart of FIG. 3, when a power supply of the MFP 10 is turned ON (S101), the MFP 10 detects whether or not the operation panel 17 is connected to the local bus 30 (S102).

When the connection of the operation panel 17 is detected, the monochrome LCD 18 integrally formed with the operation panel 17 as described above is also connected to the main system of the MFP 10. In this case, the MFP 10 loads the display data for the monochrome LCD 18 from a proper memory (S103). After the display data is loaded, the MPU 11 displays the display data as an image on the monochrome LCD 18 (S104). The data displayed on the monochrome LCD 18 is binary data of 1 bit/pixel.

When the connection of the operation panel 17 to the local bus 30 is not detected in S102, USB enumeration is performed (S105). By the USB enumeration, the MPU 11 designates an address of the USB device connected to the USB interface 27, and after recognizing a configuration of the USB device, the MPU 11 sets an operation state of the connected USB device.

Next, the MPU 11 determines whether or not the USB device connected to the USB interface 27 is the sub system 60 (S106). When the connected USB device is not the sub system 60, the MPU 11 detects the connected USB device (S107), and executes a function of the USB device by communicating with the USB device (S108).

When the sub system 60 is detected in S106, the MPU 11 determines whether or not the LCD connected to the sub system 60 is the color LCD 38 (S109).

When the connected LCD is the color LCD 38, the sub system 60 disables the operation that is related to the monochrome display, and also loads the display data for the color LCD (S110 and S111). Then, the sub system 60 displays the display content in color on the color LCD 38 (S112).

When it is determined in S109 that the connected LCD is not the color LCD 38 (in other words, when it is determined that the connected LCD is the monochrome LCD), the sub system 60 disables the operation that is related to the color display, and also loads the display data for the monochrome LCD (S113 and S114). Then, the sub system 60 displays the display content in monochrome on the monochrome LCD (S115).

As described above, at the time of activation of the MFP 10, the MPU 11 determines whether or not the operation panel 17 is connected, and automatically determines whether the specification is the standard monochrome LCD specification (the specification of FIG. 1) or another specification. Then, when the specification is not the standard monochrome LCD specification, the MPU 11 detects the sub system 60 connected to the USB interface 27, and instructs the sub system 60 to display with the sophisticated LCD (the color LCD 38 etc.). It is sufficient for the MPU 11 to have only the function needed for the display on the standard monochrome LCD 18, and thus, the configuration of the MPU 11 can be simplified.

As described above, the copy-and-facsimile MFP 10 of the present embodiment includes the MPU 11 that can control the monochrome LCD 18, and the USB interface 27 that is used to communicate with the MPU 11. When the sub system 60, which controls the color LCD 38, is connected to the USB interface 27, the MPU 11 communicates with the sub system 60 via the USB interface 27.

When the color LCD 38, which is different from the monochrome LCD 18, is connected to the MFP 10, the sub system 60 also controls the color LCD 38 by communicating with the MPU 11. Moreover, since the sub system 60 controls the color LCD 38, the burden on the MPU 11 can be reduced. Accordingly, the configuration of the MPU 11 provided on the main system side of the MFP 10 can be simplified, the cost can be reduced, and the MFP 10 that is compatible with various LCDs can be provided.

As illustrated in FIG. 2, in the MFP 10 of the present embodiment, the sub system 60 controls the color LCD 38, and the color LCD 38, which handles the large amount of data, can be used. Further, since the sub system 60 performs complicated calculations for the color display, the configuration of the MPU 11 can be simplified.

In the MFP 10 of the present embodiment, the interface for connecting to the sub system 60 is the USB interface 27. Since the sub system 60 is connected via the serial interface, in which a cable can be easily thinned, handling in the MFP 10 can be easily performed, and the sub system 60 (the color LCD 38 and the operation panel 37) can be arranged at a proper position, enhancing scalability. Further, since the serial interface through which the communication is performed in high speed is used, even when the data amount exchanged between the MPU 11 and the sub system is large, the data content can be smoothly displayed on the color LCD 38.

In the MFP 10 of the present embodiment, the MPU 11 can acquire the content of the operations of the operation panel 37 connected to the sub system 60, by communicating with the sub system 60. When the operation panel 37 is added along with the color LCD 38, the MPU 11 recognizes the operation, and performs a proper process accordingly. Therefore, the product lineup that involves a change of the operation panel is easily adopted.

The embodiment of the present invention has been described above. The above configuration can be further changed as follows. A touch screen may be adopted to the monochrome LCD 18 and the color LCD 38, and the LCD may also function as the operation unit. By such configuration, a portion related to a user interface of the MFP can be configured as one unit, and the MFP 10 can be simplified.

The operation panel 37 may be omitted from the unit on the side of the sub system 60, and the standard operation panel 17 may be used for the color LCD specification. Alternatively, in place of the LCD, various flat panel displays such as a plasma display panel or an organic electro-luminescence display panel may be used.

In the color LCD specification of the above-described embodiment (FIG. 2), the sub system 60, the color LCD 38, and the operation panel 37 can be attached to the chassis of the MFP 10 as if they are built in. However, in place of such a built-in configuration, a unit in which the sub system 60, the color LCD 38, and the operation panel 37 are integrated may be upwardly supported, for example, by an arm towards the chassis of the MFP 10. In such a case, by having a rotational joint part provided to the arm, the user can freely change a position thereof or the like, enhancing the scalability of the MFP. Since the sub system 60 of the present embodiment is connected via the USB interface 27, even when the unit is externally arranged as described above, the USB cable can be easily pulled off to connect with the main system side.

In place of the USB interface 27, the communication between the sub system 60 and the main system side may be performed via a serial interface such as the Institute of Electrical and Electronic Engineers (IEEE) 1394. Alternatively, the sub system 60 may be connected to the main system side via a parallel interface instead of the serial interface.

The configuration of the above-described embodiment may be applied not only to the copy-and-facsimile MFP 10 but also to a copier solely including a copying function etc., to a facsimile terminal, or to an image scanner etc. Further, the configuration of the above-described embodiment may be widely applied to various image processing apparatuses and electronic devices including an LCD.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An electronic device comprising:
a monochrome liquid crystal display;
a first control unit that controls the monochrome liquid crystal display; and
an interface that is used to communicate with the first control unit,
wherein when a second control unit that controls a second liquid crystal display is connected to the interface, the first control unit communicates with the second control unit via the interface.

2. The electronic device according to claim 1, wherein the second liquid crystal display is a color liquid crystal display.

3. The electronic device according to claim 1, wherein the first control unit acquires the content of an operation of an operation unit connected to the second control unit, by communicating with the second control unit.

4. The electronic device according to claim 1, wherein when the second control unit is connected to the interface, the first control unit stops the control of the monochrome liquid crystal display.

5. The electronic device according to claim 1, wherein the interface is a serial interface.

6. The electronic device according to claim 5, wherein the serial interface is a Universal Serial Bus interface.

7. The electronic device according to claim 6, wherein the Universal Serial Bus interface is connected to a Peripheral Component Interconnect bus.

8. The electronic device according to claim 7, wherein the Peripheral Component Interconnect bus is connected to a local bus via an Application Specific Integrated Circuit, and the first control unit is connected to the local bus.

9. The electronic device according to claim 8, wherein a memory is connected to the Application Specific Integrated Circuit, and image data stored in the memory is transferred to the second control unit via the Peripheral Component Interconnect bus and the Universal Serial Bus interface.

10. The electronic device according to claim 9, wherein the second control unit further processes the image data, and the second liquid crystal display displays the processed image data.

11. An electronic device comprising:
first display means for displaying a monochrome image;
first control means for controlling the display of the monochrome image; and
interface means for communicating with the first control means,
wherein when second control means that controls second display means is connected to the interface means, the first control means communicates with the second control means via the interface means.

12. The electronic device according to claim 11, wherein the second display means displays a color image.

13. The electronic device according to claim 11, further comprising operation means that is connected to the second control means,
wherein the first control means acquires the content of an operation of the operation means by communicating with the second control means.

14. The electronic device according to claim 11, further comprising means for stopping the control of the monochrome display means when the second control means is connected to the interface means.

15. The electronic device according to claim 11, wherein the interface means is a serial interface.

16. The electronic device according to claim 15, wherein the serial interface is a Universal Serial Bus interface.

17. The electronic device according to claim 16, wherein the Universal Serial Bus interface is connected to a Peripheral Component Interconnect bus.

18. The electronic device according to claim 17, wherein the Peripheral Component Interconnect bus is connected to a local bus via an Application Specific Integrated Circuit, and the first control means is connected to the local bus.

19. The electronic device according to claim 18, further comprising storage means, wherein the storage means is connected to the Application Specific Integrated Circuit, and image data stored in the storage means is transferred to the second control means via the Peripheral Component Interconnect bus and the Universal Serial Bus interface.

20. The electronic device according to claim 19, wherein the second control means includes image data processing means, and the second display means displays the processed image data.

21. A method for controlling a display of an electronic device comprising:
detecting whether or not a monochrome display is connected to a local bus of the device and, if the monochrome display is connected to the local bus, controlling display of data on the monochrome display with a first control unit;
if the monochrome display is not connected to the local bus, detecting whether or not a color display is connected to an interface of the device and, if the color display is connected to the interface, controlling display of data on the color display with a second control unit.

22. The method according to claim 21, wherein the first control unit is contained within the electronic device, and the second control unit is a part of an external device attached to the interface.

23. The method according to claim 21, further comprising:
if the monochrome display is not connected to the local bus, detecting whether or not another monochrome display is connected to an interface of the device and, if the another monochrome display is connected to the interface, controlling display of data on the another monochrome display with the second control unit.
